(19) United States
(12) Patent Application Publication
(10) Pub. No.: US 2025/0154803 A1
(43) Pub. Date: May 15, 2025

(54) Operating Mechanism for Vehicle Doors

(71) Applicant: Illinois Tool Works Inc., Glenview, IL (US)

(72) Inventors: Andreas RUDOLF, Eibelstadt (DE); Fritz GÖBEL, Würzburg (DE)

(21) Appl. No.: 18/940,492

(22) Filed: Nov. 7, 2024

(30) Foreign Application Priority Data
Nov. 10, 2023 (DE) 10 2023 131 35

(51) Int. Cl. E05B 81/90; E05B 79/20

(52) U.S. Cl. CPC E05B 81/90; E05B 79/20

(57) ABSTRACT

The disclosure relates to an actuating device (1) for actuating at least one operable functional component of a vehicle door. The actuating device (1) has a pivot lever (3) which is pivotably mounted about an axis of rotation (2) and which, starting from an initial position, can be transferred as required into a first actuating position pivoted about the axis of rotation (2) in a first direction of rotation or into a second actuating position pivoted about the axis of rotation (2) in a second direction of rotation opposite to the first direction of rotation, in particular manually. The actuating device (1) further comprises a first force transmission mechanism (4) for transmitting at least a portion of a force generated when the pivot lever (3) is moved from the initial position to the first actuating position to the at least one operable functional component of the vehicle door and a second force transmission mechanism (5) for transmitting at least a portion of a force generated when the pivot lever (3) is moved from the initial position to the second actuating position to the at least one operable functional component of the vehicle door. According to the disclosure, a coupling mechanism is provided in particular, which is designed to selectively introduce at least part of the force generated when the pivot lever (3) is moved from the initial position into the first actuation position or into the second actuation position exclusively into the first force transmission mechanism (4) or into the second force transmission mechanism (5).

### RELATED APPLICATION

The present application claims the benefit of German Patent Application No. 10 2023 131 353.3, filed Nov. 10, 2023, titled “Operating Mechanism for Vehicle Doors,” the contents of which are hereby incorporated by reference.

### BACKGROUND

Vehicle doors are also locked in their closed position, for example, to prevent theft. For this purpose, there is a separate locking mechanism in the vehicle door that must be unlocked. Various locking and unlocking mechanisms are known from the prior art. For example, in a central locking system, an electromagnetic signal is generated that can be used by the locking mechanism to lock or unlock all of the vehicle's doors. This means that the user can first unlock the vehicle remotely and then use the door lever to open the vehicle door, i.e. disengage it and pull it open at the same time.

Various mechanisms are also known for locking and unlocking the vehicle door from inside the vehicle. In most cases, the vehicle door can be unlocked from the inside of the vehicle by actuating the door lever. Pulling the door lever can not only release the vehicle door, but also, at the same time, unlock the locking mechanism. This is a safety mechanism that ensures that the occupants can leave the vehicle at any time, even when the door is locked, without having to unlock the doors separately before actuating the door lever.

Locking the vehicle doors from the inside can be achieved, for example, by means of a locking button or a locking switch in the interior.

The fact that the actuating mechanisms for vehicle doors known from the prior art cannot be actuated intuitively is seen as problematic. Accordingly, the object of the present disclosure is to provide a vehicle door actuating mechanism that is particularly easy and intuitive to use to control the opening and closing mechanisms of the vehicle doors.

### SUMMARY

The present disclosure relates generally to an actuating device, substantially as illustrated by and described in connection with at least one of the figures, as set forth more completely in the claims.

### DRAWINGS

The foregoing and other objects, features, and advantages of the devices, systems, and methods described herein will be apparent from the following description of particular examples thereof, as illustrated in the accompanying figures; where like or similar reference numbers refer to like or similar structures. The figures are not necessarily to scale, emphasis instead being placed upon illustrating the principles of the devices, systems, and methods described herein.

FIG. 1 illustrates schematically and in a partially cut isometric view, an exemplary embodiment of the actuating device according to the disclosure, wherein the pivot lever of the actuating device is in its initial position.

FIG. 2 illustrates a schematic, isometric view of the coupling lever of the coupling mechanism used with the actuating device according to FIG. 1.

FIG. 3 illustrates in a schematic and side view, the actuating device according to FIG. 1.

FIG. 4 illustrates schematically and in an isometric view, the operative connection between the pivot lever of the actuating device according to FIG. 1 and the coupling lever of the coupling mechanism.

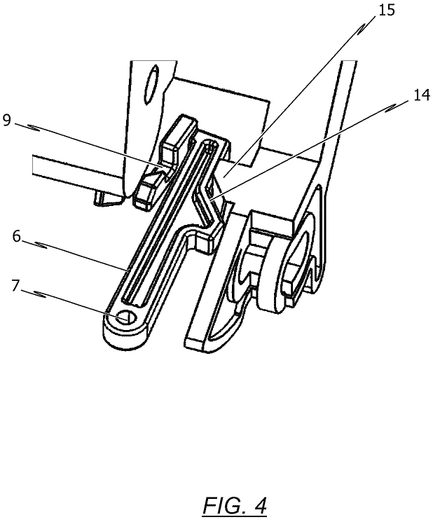

FIG. 5 illustrates in a schematic and isometric view a detail of the operative connection between the pivot lever and the coupling lever according to FIG. 4.

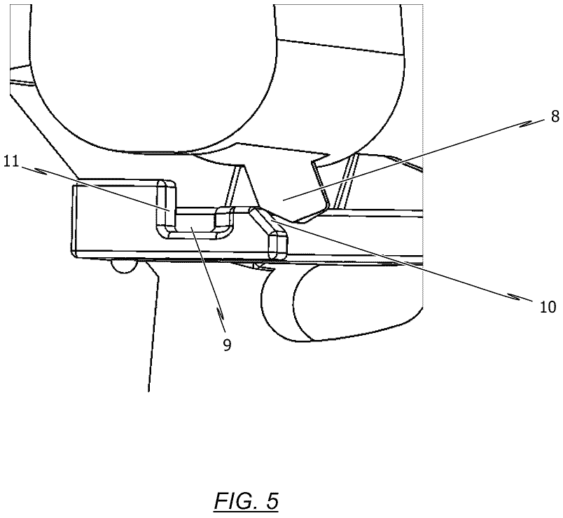

FIG. 6 illustrates schematically and in a side view, the exemplary embodiment of the actuating device according to the disclosure, as shown in FIG. 1, but in a state in which the pivot lever of the actuating device is moved from the initial position shown in FIG. 3 to a first actuating position.

FIG. 7 illustrates schematically and in an isometric view the operative connection between the pivot lever and the coupling lever of the coupling mechanism of the actuating device in the first actuating position of the pivot lever shown in FIG. 6.

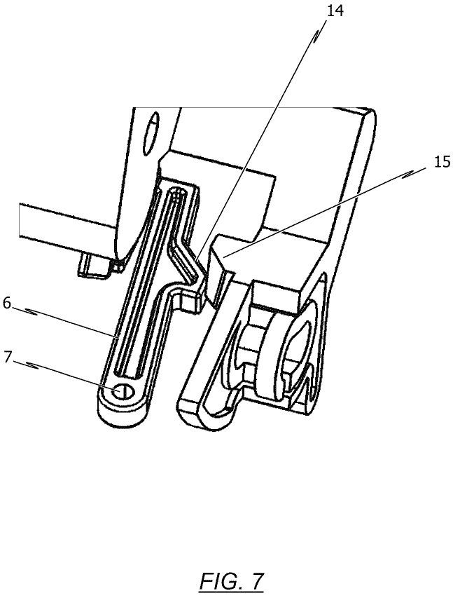

FIG. 8 illustrates schematically and in an isometric view a detail of the active connection according to FIG. 7.

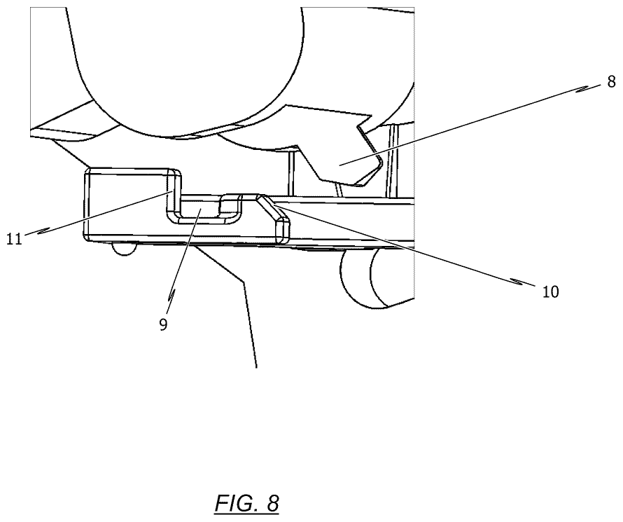

FIG. 9 illustrates schematic and side view of the actuating device according to FIG. 1 in a state in which the pivot lever is in its second actuating position.

FIG. 10 illustrates schematically and in an isometric view the (non-existent) operative connection between the pivot lever and the coupling lever of the coupling mechanism of the actuating device in the state shown in FIG. 9.

FIG. 11 illustrates schematically a detailed view of the active compound according to FIG. 10.

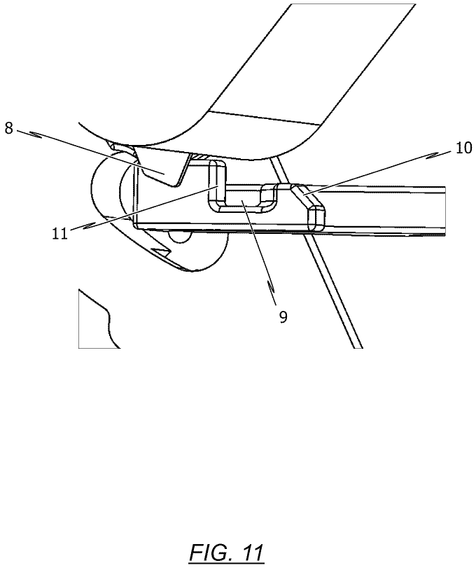

FIG. 12 illustrates schematic and side view of the actuating device according to FIG. 1 in a locked position of the coupling lever of the coupling mechanism in an intermediate position of the pivot lever.

FIG. 13 illustrates schematically and in an isometric view an operative connection between the coupling lever and the pivot lever of the actuating device in the state shown in FIG. 12.

FIG. 14 illustrates a detailed view of the active compound shown in FIG. 13.

### DETAILED DESCRIPTION

References to items in the singular should be understood to include items in the plural, and vice versa, unless explicitly stated otherwise or clear from the text. Grammatical conjunctions are intended to express any and all disjunctive and conjunctive combinations of conjoined clauses, sentences, words, and the like, unless otherwise stated or clear from the context. Recitation of ranges of values herein are not intended to be limiting, referring instead individually to any and all values falling within and/or including the range, unless otherwise indicated herein, and each separate value within such a range is incorporated into the specification as if it were individually recited herein. In the following description, it is understood that terms such as “first,” “second,” “top,” “bottom,” “side,” “front,” “back,” and the like are words of convenience and are not to be construed as limiting terms. For example, while in some examples a first side is located adjacent or near a second side, the terms “first side” and “second side” do not imply any specific order in which the sides are ordered.

The terms “about,” “approximately,” “substantially,” or the like, when accompanying a numerical value, are to be construed as indicating a deviation as would be appreciated by one of ordinary skill in the art to operate satisfactorily for an intended purpose. Ranges of values and/or numeric values are provided herein as examples only, and do not constitute a limitation on the scope of the disclosure. The use of any and all examples, or exemplary language (“e.g.,” “such as,” or the like) provided herein, is intended merely to better illuminate the disclosed examples and does not pose a limitation on the scope of the disclosure. The terms “e.g.,” and “for example” set off lists of one or more non-limiting examples, instances, or illustrations. No language in the specification should be construed as indicating any unclaimed element as essential to the practice of the disclosed examples.

The term “and/or” means any one or more of the items in the list joined by “and/or.” As an example, “x and/or y” means any element of the three-element set {(x), (y), (x, y)}. In other words, “x and/or y” means “one or both of x and y”. As another example, “x, y, and/or z” means any element of the seven-element set {(x), (y), (z), (x, y), (x, z), (y, z), (x, y, z)}. In other words, “x, y, and/or z” means “one or more of x, y, and z.”

The present disclosure relates to an actuating device for actuating at least one actuable functional component of a vehicle door and to a corresponding vehicle door with such an actuating device. The vehicle door according to the disclosure is in particular an interior vehicle door.

The actuating device is used in particular to actuate a door lock of such a vehicle door as required, i.e. to lock or unlock it. It is known from the prior art that vehicle doors can be opened and closed by door levers. When the vehicle doors are closed, they automatically lock. When the doors are opened, the door lever is pulled to release the latch and unlatch the vehicle door so that it can be pulled open or slid open by the user.

Accordingly, the disclosure relates in particular to an actuating device for actuating at least one actuable functional component of a vehicle door, wherein the actuating device has a pivot lever that is mounted so as to be pivotable about an axis of rotation and which, starting from an initial position, as required, into a first actuating position, pivoted about the axis of rotation in a first direction of rotation, or into a second actuating position, pivoted about the axis of rotation in a second direction of rotation opposite to the first direction of rotation, in particular manually.

Optionally, the pivot lever can also be transferred from its initial position to an intermediate position between the initial position and the first actuating position, in particular by hand.

The actuating device according to the disclosure also has a first force transmission mechanism, in particular in the form of a Bowden cable or with a Bowden cable, for transmitting at least part of a force generated when moving the pivot lever from the initial position into the first actuating position to the at least one operable functional component of the vehicle door. In addition, the actuating device according to the disclosure has a second force transmission mechanism, in particular in the form of a Bowden cable or with a Bowden cable, for transmitting at least part of a force generated when the pivot lever is moved from the initial position into the second actuating position to the at least one operable functional component of the vehicle door.

Finally, the actuating device according to the disclosure comprises a coupling mechanism which is designed to selectively introduce the at least part of the force generated when moving the pivot lever from the initial position into the first actuating position or into the second actuating position exclusively into the first force transmission mechanism or into the second force transmission mechanism.

Preferably, the coupling mechanism is designed to decouple an operative connection between the pivot lever and the second force transmission mechanism when the pivot lever is moved from its initial position into the first actuating position, and to decouple an operative connection between the pivot lever and the first force transmission mechanism when the pivot lever is moved from its initial position into the second actuating position.

According to the realizations of the actuating device according to the disclosure, it is envisaged that the coupling mechanism has a coupling lever that is mounted so as to be pivotable about a pivot axis, wherein the pivot axis about which the coupling lever is mounted so as to be pivotable extends at least essentially perpendicular to the axis of rotation about which the pivot lever is mounted so as to be pivotable.

According to the design variants of the last-mentioned design form of the actuating device according to the disclosure, it is envisaged that the coupling lever can be pivoted between an starting position and a locked position by actuating the pivot lever, wherein the coupling lever is present in its locked position or is transferred to its locked position when the pivot is in its first actuating position or is transferred to its first actuating position, or wherein the coupling lever is in its locked position or is transferred to its locked position when the pivot lever, starting from its initial position, is in an intermediate position between its initial position and its first actuating position or is transferred to the intermediate position.

In this context, it is particularly envisaged that, when the coupling lever is in the locked position, the pivot lever is detachably locked by the coupling lever in its first actuating position or in its intermediate position.

For this purpose, it is possible for the pivot lever to have a locking projection which, when the pivot lever is moved from the initial position of the pivot lever to the first actuating position of the pivot lever or when the pivot lever is moved from the initial position of the pivot lever to the intermediate position of the pivot lever, strikes against an approach slope of a locking region of the coupling lever, wherein the locking region of the coupling lever and/or the locking projection of the pivot lever are/is designed to be elastic in such a way that, when the locking projection of the pivot lever abuts against the approach slope of the locking region and upon a further movement of the pivot lever into the first actuating position of the pivot lever or into the intermediate position of the pivot lever, the locking region of the coupling lever relative to the locking projection of the pivot lever and enables the locking projection of the pivot lever to be transferred into a receiving section of the locking region of the coupling lever, wherein the pivot lever is locked in a releasable manner after the locking projection of the pivot lever has been transferred into the receiving section of the locking region of the coupling lever.

According to realizations of the actuating device according to the disclosure, it is provided in particular in this context that the receiving section of the locking region of the coupling lever has a stop surface against which the locking projection of the pivot lever, when the locking projection of the pivot lever is received in the receiving section of the locking region of the coupling lever, so that further pivoting of the pivot lever in the first direction of rotation is blocked.

In this case, it is advantageous for the receiving section of the locking region of the coupling lever to have a surface that is opposite the stop surface and faces the approach slope of the locking region of the coupling lever, which runs obliquely with respect to the approach slope and stop surface that after the transfer of the locking projection of the pivot lever into the receiving section of the locking region of the coupling lever and upon pivoting of the pivot lever in the second direction of rotation, the coupling lever is pivoted out of its locked position in the direction of its initial position.

In some embodiments of the actuating device according to the disclosure, the pivot lever has a control projection which, when the pivot lever is moved into its first actuating position, strikes against a control region of the coupling lever and, when the pivot lever is pivoted further in the first direction of rotation, pushes the coupling lever into its locked position.

In principle, however, the pivot lever should not be in an active connection with the coupling lever in the second actuating position of the pivot lever.

According to the realizations of the disclosure-based actuating device, it is envisaged that in the first actuating position of the pivot lever, with the aid of the first force transmission mechanism, a door lock of the vehicle door, which is in particular a vehicle side door, is transferred into a mechanically locked state, and wherein in the second actuating position of the pivot lever, with the aid of the second force transmission mechanism, the door lock of the vehicle door is transferred into a mechanically unlocked state.

The disclosure also relates to a vehicle door, in particular a vehicle interior door, wherein the vehicle door has a door lock that can be transferred as needed into a mechanically locked state or into a mechanically unlocked state, and wherein the vehicle door has an actuating device of the aforementioned type according to the disclosure for manipulating the door lock.

The actuating device according to the disclosure is in particular a door lock actuator for a vehicle door of a motor vehicle. The door lock actuator is assigned to a door lock of the vehicle door.

The disclosure also relates to a module for a side door of a vehicle with an actuating device, designed in particular as a door lock actuator, of the type mentioned above that is based on the disclosure.

The vehicle door, in particular a side door, preferably has a door handle or door grab handle with one or more fastening regions and with at least one handle region that can be grasped with one hand behind it and preferably grasped completely around it over 360°, wherein the handle region has an axial extent. Preferably, the pivot lever of the actuating device according to the disclosure is integrated in the handle region of the door-closing handle of the vehicle door, with the axis of rotation of the pivot lever being aligned at least essentially transversely to the axial extent.

The unusual orientation of the pivot axis of the pivot lever transverse to the axial extent of the handle region, especially in passenger cars, makes it possible to integrate the pivot lever directly into the handle region of the door-closing handle, and not above it, in a space-saving way, while at the same time maintaining a relatively long lever arm. This way, a particularly space-saving arrangement with optimized functionality is achieved.

The disclosure also relates to a vehicle, in particular a passenger car. In the following, reference is made in part to the vehicle coordinate system, where the X-direction is forward in the direction of travel, the Z-direction is up, and the Y-direction is across the X-direction from passenger to driver.

The term “actuating the door lock” refers to the opening/closing of the door latch and/or the locking/unlocking of the door.

The mechanical actuating device according to the present disclosure preferably allows a purely mechanical actuation of the door lock, by means of which the door lock can be unlocked and/or the door catch can be opened so that the vehicle door can be swung open. The actuating device, which is designed in particular as a door lock actuator, is preferably set up to carry out the mechanical actuation completely without electrical energy (electricity), so that this type of actuation can also be tensioned in an emergency without on-board voltage. In this regard, the actuating device has, for example, a Bowden cable and/or a gear mechanism and/or a linkage as a force transmission mechanism.

The coupling section on the pivot lever of the actuating device according to the disclosure is preferably a coupling mechanism by means of which a pivoting movement of the pivot lever can be transmitted to the first and/or second force transmission mechanism.

The pivot lever of the actuating device is preferably a control element by means of which a user can operate the mechanical actuating device. The pivot lever has a rest position (initial position) and at least one mechanical actuation position (first and second actuation position), in which a functional component of the vehicle door, in particular a door lock, is or can be mechanically actuated.

Accordingly, the present disclosure relates to an actuating mechanism for vehicle doors, wherein the actuating mechanism has the following: an actuating means which can be transferred from a basic position into an open position, in particular to disengage, in order to open a vehicle door, and from the basic position into a closed position, in order to lock the vehicle door, a locking means for actuating a vehicle door lock, wherein the locking means can be moved between a locking position for locking the vehicle door and an unlocking position for unlocking a vehicle door, wherein the actuating mechanism is designed such that the actuating means is decoupled from the locking means when the actuating means is transferred from the basic position into the opening position and such that the actuating means, when transferred from the basic position into the closing position, interacts with the locking means such that the locking means is transferred from the unlocking position into the locking position.

The actuating mechanism of the present disclosure enables the user to open and close the vehicle door (latch and unlatch) and, on the other hand, to lock and unlock it using only one actuating means. To do this, the actuating means only needs to be moved into two different positions. When the actuating element is moved between its three different positions, it not only acts as a door lever, but also simultaneously controls the vehicle door lock.

According to a further embodiment, the actuating means has at least one cam follower which is designed to transfer a movement of the actuating means to the locking means when the actuating means is transferred from the basic position to the closed position. The driver can be designed, for example, as a pin that extends beyond the actuating means and is designed to interact with a corresponding surface of the locking means.

According to a further embodiment, the actuating means is designed such that, when the actuating means is transferred from the closed position to the basic position, it interacts with the locking means in such a way that the locking means is transferred from the locking position to the unlocking position.

Accordingly, the actuating device can be used not only to lock the door, but also to actively unlock it. Preferably, the actuating element is designed in such a way that it can be transferred from its closed position to the basic position and also to the open position with one movement. This means that the vehicle door is unlocked and released with just one hand movement.

According to a further embodiment, the at least one driver is designed to transfer a movement of the actuating means to the locking means when the actuating means is transferred from the closed position to the basic position. One driver can interact with a first surface of the locking means to transfer the locking means into the locking position. To return the locking means to the unlocked position, the cam can therefore interact with a second surface of the locking means.

Alternatively, the actuating means can have a second cam follower which is designed to transfer a movement of the actuating means to the locking means when the actuating means is transferred from the closed position to the basic position. The first and second drivers can, for example, be arranged on opposite surfaces of the locking means.

In a further embodiment, the actuating means is biased into the basic position.

In another embodiment, the actuation mechanism comprises a biasing element associated with the locking means for defining a force threshold for transferring the locking means from the unlocking position to the locking position. The prestressing element, for example, can be a spring element that is connected to a sliding surface of the locking mechanism. A step of the surface of the locking means can be designed to deform the spring element until it slips over the step and accordingly releases the movement of the locking means. The force threshold mentioned above must be overcome in order to deform the spring element, so that moving the locking mechanism between the unlocked and locked position requires an amount of force equal to the force threshold. The force threshold can therefore be felt by the user when they want to move the actuating clement from the basic position to the closed position.

According to a further embodiment, the actuating means is connectable to a pull cable, in particular a first Bowden cable, and designed to move the pull cable when the actuating means is transferred from its basic position to its opening position, wherein the actuating means is designed to execute a movement relative to the pull cable in order not to move the pull cable when the actuating means is transferred from its basic position to its closing position. According to this embodiment, the actuating means can be connected to the latching mechanism of the vehicle door via a pull cable. However, according to this embodiment, the pull cable is only activated when the actuating means is transferred from its basic position to its opening position.

In another embodiment, the actuating means has an elongated hole for receiving a barrel of a pull cable, wherein the elongated hole is arranged to allow relative movement between the pull cable and the actuating means when the actuating means is transferred from its basic position to its closed position. In particular, according to this embodiment, the pull cable is located at a first end of the slot when the actuating means is in its basic position. As soon as the actuating mechanism is moved to its closed position, the pulley of the pull cable is guided along the slot, relative to the actuating mechanism.

In another embodiment, the locking mechanism can be connected to a pressure cable, in particular a second Bowden cable, and is designed to move the pressure cable when the locking mechanism is moved from its unlocked position to its locked position. In other words, the actuating mechanism of the present disclosure can be used to actuate two different Bowden cables. The second Bowden cable is connected in particular to the locking mechanism of the vehicle door. The locking mechanism can exert a pushing force on the pull cable to actuate the locking mechanism and lock the vehicle door accordingly. According to this embodiment, the actuation means is designed to activate the first Bowden cable, while the locking means is designed to activate the second Bowden cable. However, the actuating means is also designed to move the locking means, so that moving the actuating means by the user can actuate both Bowden cables.

According to a further embodiment, the locking means is designed such that a first force threshold must be overcome to transfer the locking element from the unlocking position into the locking position and that a second force threshold must be overcome to transfer the locking means from the locking position into the unlocking position, wherein the first and second force thresholds are preferably different. The locking means may accordingly be biased in either of two positions, i.e. the locking position and the unlocking position.

The exemplary embodiment of the actuating device 1 according to the disclosure shown in the drawings has a pivot lever 3 pivotably mounted about an axis of rotation 2.

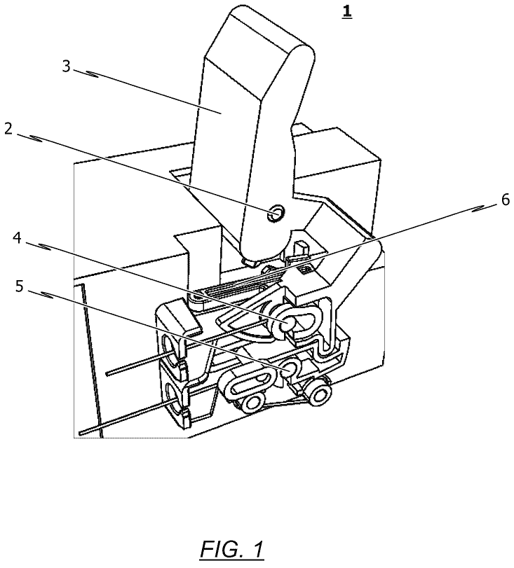

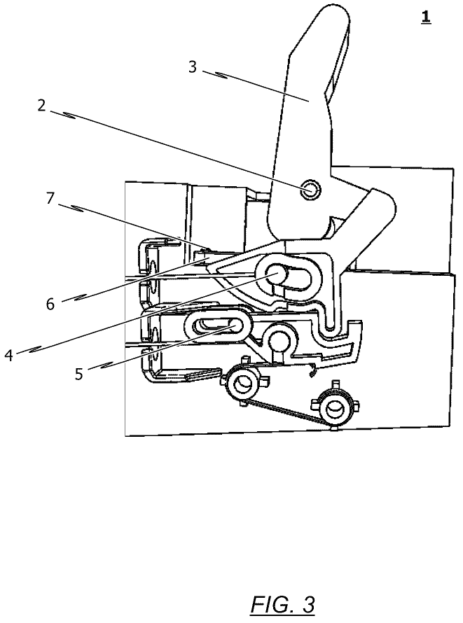

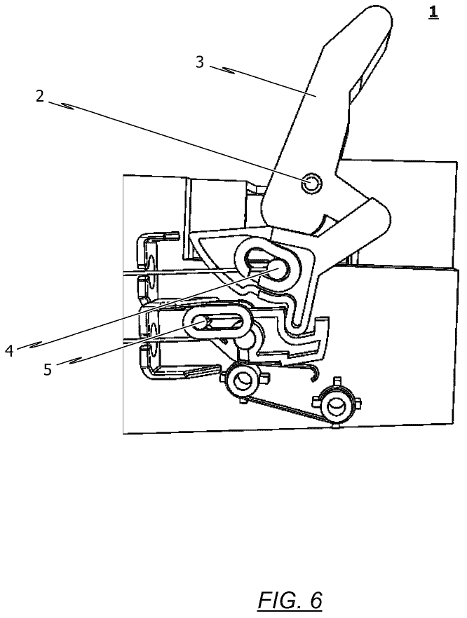

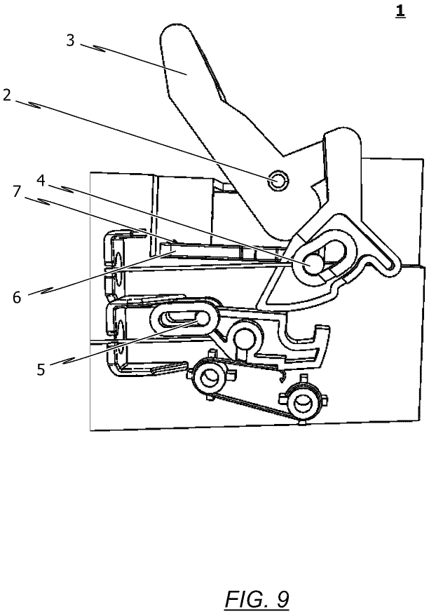

Starting from an initial position shown, for example, in FIG. 1 or FIG. 3, the pivot lever 3 can be moved manually as required into a first actuating position pivoted about the axis of rotation 2 of the pivot lever 3 in a first direction of rotation (see FIG. 6) or into a second actuating position pivoted about the axis of rotation 2 of the pivot lever 3 in a second direction of rotation opposite to the first direction of rotation (see FIG. 9).

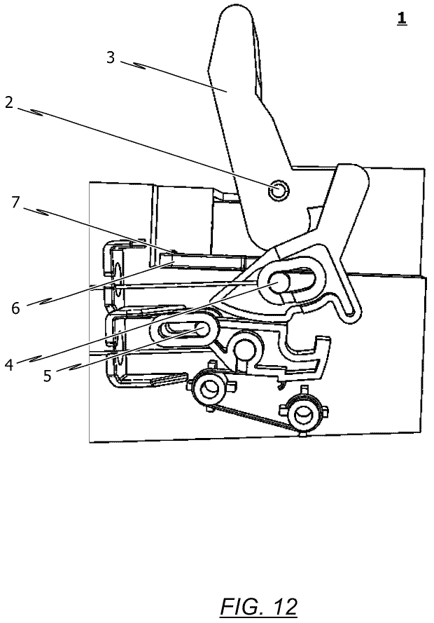

The pivot lever 3 can also be moved manually from its starting position (see FIG. 1 or FIG. 3) to an intermediate position between the starting position and the first actuating position. The intermediate position is shown in FIG. 12.

The exemplary embodiment of the actuating device 1 shown in the drawings also has a first force transmission mechanism 4, which is designed to transmit at least part of a force generated when the pivot lever 3 of the actuating device 1 is moved from the initial position to the first actuating position to an actuatable functional component of the vehicle door. The first power transmission mechanism 4 is in particular a Bowden cable.

Furthermore, in the exemplary embodiment of the actuating device 1 according to the disclosure, a second force transmission mechanism 5, in particular in the form of a (second) Bowden cable, is used, wherein the second force transmission mechanism 5 serves to transmit at least a portion of a force generated when the pivot lever 3 of the actuating device 1 is moved from the initial position to the second actuating position to the operable functional component of the vehicle door.

Finally, the exemplary embodiment of the actuating device 1 according to the disclosure comprises a coupling mechanism.

The coupling mechanism is designed to selectively introduce at least a portion of the force generated when transferring the pivot lever 3 of the actuating device 1 from the initial position to the first actuating position or from the initial position to the second actuating position exclusively into the first force transmission mechanism 4 or into the second force transmission mechanism 5.

For this purpose, the coupling mechanism is designed to decouple an operative connection between the pivot lever 3 of the actuating device 1 and the second force transmission mechanism 5 when the pivot lever 3 is transferred from its initial position to the first actuating position.

In addition, the coupling mechanism of the actuating device 1 according to the disclosure is designed to decouple an operative connection between the pivot lever 3 of the actuating device 1 and the first force transmission mechanism 4 when the pivot lever 3 is transferred from its initial position to the second actuating position.

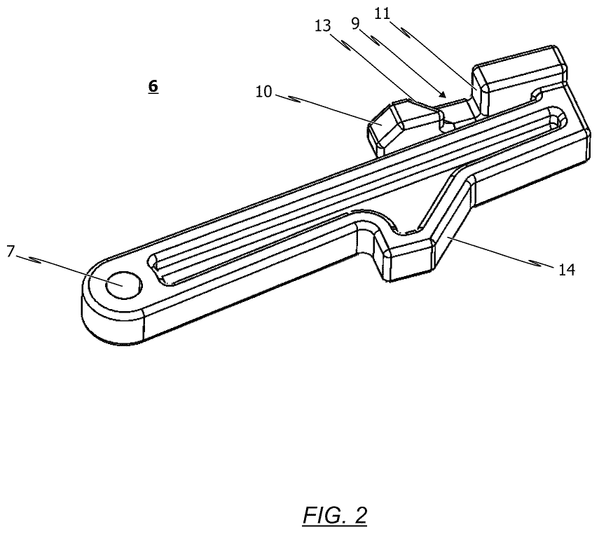

In the exemplary embodiment of the actuating device 1 according to the disclosure shown in the drawings, the coupling mechanism has a coupling lever 6 pivotably mounted about a pivot axis 7. The coupling lever 6 used in the exemplary embodiment of the actuating device 1 according to the disclosure is shown schematically and in an isometric view in FIG. 2.

Specifically, the coupling lever 6 is pivotably mounted about a pivot axis 7, wherein the pivot axis 7, about which the coupling lever 6 is pivotably mounted, extends at least substantially perpendicular to the axis of rotation 2, about which the pivot lever 3 of the actuating device 1 is pivotably mounted.

In particular, it is provided that the coupling lever 6 of the coupling mechanism can be pivoted between an initial position and a locked position by actuating the pivot lever 3. The coupling lever 6 is in its locked position or is transferred to its locked position when the pivot lever 3 of the actuating device 1 is in its first actuating position or is transferred to its first actuating position.

In the exemplary embodiment of the actuating device 1 according to the disclosure shown in the drawings, on the other hand, it is provided that the coupling lever 6 of the coupling mechanism is in its locked position or is transferred to its locked position when the pivot lever 3—starting from its initial position—is in an intermediate position between the initial position and the first actuating position or is transferred to this intermediate position.

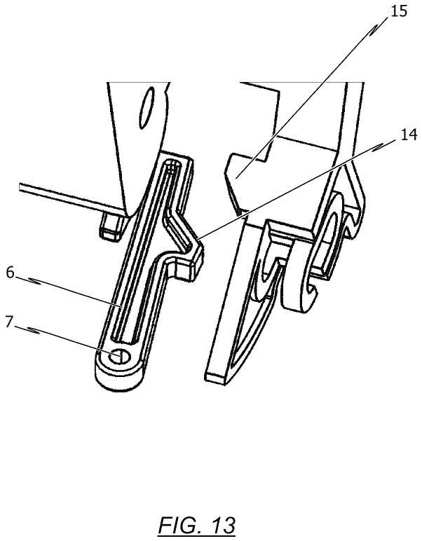

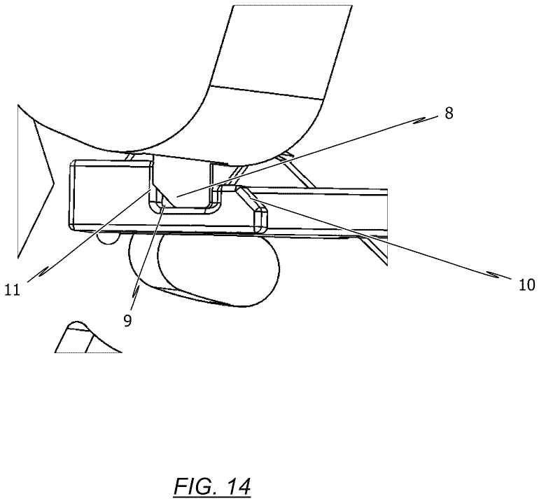

In the locked position of the coupling lever 6—as shown in FIG. 13 and FIG. 14—the pivot lever 3 of the actuating device 1 is releasably locked in its intermediate position by the coupling lever 6.

For this purpose, the pivot lever 3 has a locking projection 8 which, when the pivot lever 3 of the actuating device 1 is moved from the initial position of the pivot lever 3 to the intermediate position of the pivot lever 3, abuts against an approach slope 10 of a locking region 9 of the coupling lever 6.

The locking region 9 of the coupling lever 6 is designed to be particularly partially or partially elastic, that when the locking projection of the pivot lever 3 abuts against the approach slope 10 of the locking region 9 and during a further movement of the pivot lever 3 into the first actuation position or into the intermediate position of the pivot lever 3, the locking region 9 of the coupling lever 6 at least partially or partially elastically recedes and enables the locking projection 8 of the pivot lever 3 to be transferred into a receiving section of the locking region 9 of the coupling lever 6. After transferring the locking projection 8 of the pivot lever 3 into the receiving section of the locking region 9 of the coupling lever 6, the pivot lever 3 is detachably locked.

In the exemplary embodiment of the actuating device 1 according to the disclosure shown in the drawings, it is provided in this context that the receiving section of the locking region 9 of the coupling lever 6 has a stop surface 11 against which the locking projection 8 of the pivot lever 3 abuts when the locking projection 8 of the pivot lever 3 is received in the receiving section of the locking region 9 of the coupling lever 6, so that further pivoting of the pivot lever 3 in the first direction of rotation is then blocked.

As can be seen in particular from the isometric view of the coupling lever 6 according to FIG. 2, in the exemplary embodiment of the actuating device 1 according to the disclosure it is provided that the receiving section of the locking region 9 of the coupling lever 6 has a stop surface 11 against which the locking projection 8 of the pivot lever 3 of the actuating device 1 abuts, when the locking projection 8 of the pivot lever 3 is received in the receiving section of the locking region 9 of the coupling lever 6, so that further pivoting of the pivot lever 3 in the first direction of rotation is then blocked.

Furthermore, it can be seen in particular from the schematic, isometric view according to FIG. 2 shows that the receiving section of the locking region 9 of the coupling lever 6 has a surface 13 opposite the stop surface 11 and facing the approach slope 10 of the locking region 9 of the coupling lever 6, which runs at an angle with respect to the approach slope 10 and with respect to the stop surface 11, that after the transfer of the locking projection 8 of the pivot lever 3 into the receiving section of the locking region 9 of the coupling lever 6 and when the pivot lever 3 is pivoted in the second direction of rotation, the coupling lever 6 is pivoted out of its locked position in the direction of its initial position.

In the exemplary embodiment of the actuating device 1 according to the disclosure shown in the drawings, it is further provided that the pivot lever 3 has a control projection 14 which, when the pivot lever 3 is moved into its first actuating position, abuts against a control region 15 of the coupling lever 6 and, when the pivot lever 3 is pivoted further in the first direction of rotation, presses the coupling lever 6 into its locked position.

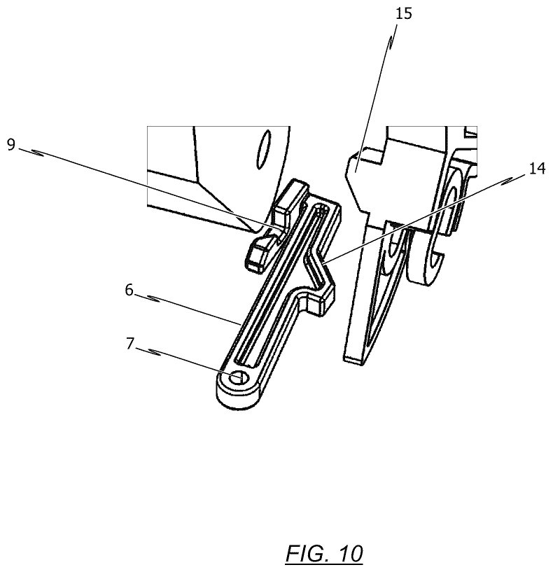

As can be seen in particular from the illustration in FIG. 10, in the second actuation position of the pivot lever 3, the pivot lever 3 is not in operative connection with the coupling lever 6 of the coupling mechanism.

While the present method and/or system has been described with reference to certain implementations, it will be understood by those skilled in the art that various changes may be made and equivalents may be substituted without departing from the scope of the present method and/or system. In addition, many modifications may be made to adapt a particular situation or material to the teachings of the present disclosure without departing from its scope. For example, block and/or components of disclosed examples may be combined, divided, re-arranged, and/or otherwise modified. Therefore, the present method and/or system are not limited to the particular implementations disclosed. Instead, the present method and/or system will include all implementations falling within the scope of the appended claims, both literally and under the doctrine of equivalents.

### LIST OF REFERENCE NUMBERS

1 Actuating device
2 Axis of rotation
3 Pivot lever
4 First power transmission mechanism/first Bowden cable
5 Second power transmission mechanism/second Bowden cable
6 Coupling mechanism/coupling lever
7 Pivot axis of the coupling lever
8 Locking projection of the pivot lever
9 Locking region of the coupling lever
10 Approach slope of the locking region
11 Stop surface
12 Approach slope
13 Sloping surface
14 Control advantage
15 Control region of the coupling lever

What is claimed is:

1. An actuating device (1) for actuating at least one operable functional component of a vehicle door, wherein the actuating device (1) has the following:
a pivot lever (3) which is pivotably mounted about an axis of rotation (2) and which, starting from an initial position, can be moved as required into a first actuating position pivoted about the axis of rotation (2) in a first direction of rotation or into a second actuating position pivoted about the axis of rotation (2) in a second direction of rotation opposite to the first direction of rotation manually;
a first force transmission mechanism (4), in the form of a Bowden cable or with a Bowden cable, for transmitting at least part of a force generated when transferring the pivot lever (3) from the initial position to the first actuation position to the at least one actuatable functional component of the vehicle door;
a second force transmission mechanism (5), in the form of a Bowden cable or with a Bowden cable, for transmitting at least part of a force generated when transferring the pivot lever (3) from the initial position to the second actuation position to the at least one actuatable functional component of the vehicle door; and
a coupling mechanism which is designed to selectively introduce at least part of the force generated when the pivot lever (3) is moved from the initial position into the first actuating position or into the second actuating position exclusively into the first force transmission mechanism (4) or into the second force transmission mechanism (5).

2. The actuating device (1) according to claim 1, wherein the coupling mechanism is designed to decouple an operative connection between the pivot lever (3) and the second force transmission mechanism (5) when the pivot lever (3) is transferred from its initial position to the first actuating position, and to decouple an operative connection between the pivot lever (3) and the first force transmission mechanism (4) when the pivot lever (3) is transferred from its initial position to the second actuating position.

3. The actuating device (1) according to claim 1, wherein the coupling mechanism has a coupling lever (6) which is pivotably mounted about a pivot axis (7), wherein the pivot axis (7) about which the coupling lever (6) is pivotably mounted extends at least substantially perpendicularly to the axis of rotation (2) about which the pivot lever (3) is pivotably mounted.

4. The actuating device (1) according to claim 3, wherein the coupling lever (6) can be pivoted between an initial position and a locked position by actuating the pivot lever (3), wherein the coupling lever (6) is in its locked position or is transferred to its locked position when the pivot lever (3) is in its first actuating position or is transferred to its first actuating position, or wherein the coupling lever (6) is present in its locked position or is transferred to its locked position when the pivot lever (3), starting from its initial position, is present in an intermediate position between its initial position and its first actuation position or is transferred to the intermediate position.

5. The actuating device (1) according to claim 4, wherein, in the locked position of the coupling lever (6), the pivot lever (3) is releasably locked in its first actuating position or in its intermediate position by the coupling lever (6).

6. The actuating device (1) according to claim 5, wherein the pivot lever (3) has a locking projection (8) which, when the pivot lever (3) is transferred from the initial position of the pivot lever (3) into the first actuating position of the pivot lever (3) or when the pivot lever (3) is transferred from the initial position of the pivot lever (3) into the intermediate position of the pivot lever (3), abuts against an approach slope (10) of a locking region (9) of the coupling lever (6), wherein the locking region (9) of the coupling lever (6) and/or the locking projection (8) of the pivot lever (3) are/is designed to be elastic in such a way that when the locking projection (10) of the pivot lever (3) abuts against the approach slope (10) of the locking region (9) and during a further movement of the pivot lever (3) into the first actuation position of the pivot lever (3) or into the intermediate position of the pivot lever (3), the locking area (3), the locking region (9) of the coupling lever (6) is moved relative to the locking projection (8) of the pivot lever (3) and a transfer of the locking projection (10) of the pivot lever (3) into a receiving section of the locking region (9) of the coupling lever (6) is enabled, wherein after the transfer of the locking projection (10) of the pivot lever (3) into the receiving section of the locking region (9) of the coupling lever (6), the pivot lever (3) is releasably locked.

7. The actuating device (1) according to claim 6, wherein the receiving section of the locking region (9) of the coupling lever (6) has a stop in the form of a stop surface (11), against which the locking projection (8) of the pivot lever (3) abuts when the locking projection (8) of the pivot lever (3) is received in the receiving section of the locking region (9) of the coupling lever (6), so that further pivoting of the pivot lever (3) in the first direction of rotation is then blocked.

8. The actuating device (1) according to claim 7, wherein the receiving section of the locking region (9) of the coupling lever (6) has a surface (13) which is opposite the stop or the stop surface (11) and facing the approach slope (10) of the locking region (9) of the coupling lever (6), which surface (13) extends obliquely with respect to the approach slope (10) and with respect to the stop surface (11) in such a way that after the transfer of the locking projection (10) of the pivot lever (3) into the receiving section of the locking region (9) of the coupling lever (6) and when the pivot lever (3) is pivoted in the second direction of rotation, the coupling lever (6) is pivoted out of its locked position in the direction of its initial position.

9. The actuating device (1) according to claim 4, wherein the pivot lever (3) has a control projection (14) which, when the pivot lever (3) is moved into its first actuating position, abuts against a control region (15) of the coupling lever (6) and, when the pivot lever (3) is pivoted further in the first direction of rotation, presses the coupling lever (6) into its locked position.

10. The actuating device (1) according to claim 3, wherein in the second actuating position of the pivot lever (3), the pivot lever (3) is not in operative connection with the coupling lever (6).

11. The actuating device (1) according to claim 1, wherein, in the first actuating position of the pivot lever (3), a door lock of the vehicle door, which is a vehicle side door, is transferred into a mechanically locked state with the aid of the first force transmission mechanism (4), and wherein, in the second actuating position of the pivot lever (3), the door lock of the vehicle door is transferred into a mechanically unlocked state with the aid of the second force transmission mechanism (5).

12. A vehicle door comprising a door lock that can be transferred as required into a mechanically locked state or into a mechanically unlocked state, and wherein the vehicle door has the actuating device (1) according to claim 1 configured to manipulate the door lock.
